(19) United States
(12) Patent Application Publication
(10) Pub. No.: US 2022/0126635 A1
(43) Pub. Date: Apr. 28, 2022

(54) TIRE COMPRISING A SEALANT LAYER AND A SOUND-ABSORBING ELEMENT

(71) Applicant: Bridgestone Europe NV/SA [BE/BE], Zaventem (BE)

(72) Inventor: Enrico Fresch, Rome (IT)

(21) Appl. No.: 17/427,711

(22) PCT Filed: Jan. 31, 2020
(86) PCT No.: PCT/IB2020/050793

§ 371 Date: Aug. 2, 2021

(30) Foreign Application Priority Data
Feb. 5, 2019 (IT) 102019000001641

(51) Int. Cl. B60C 19/00; B29D 30/06

(52) U.S. Cl. CPC B60C 19/002; B29D 2030/0686; B29D 2030/0682; B29D 30/06

(57) ABSTRACT

A tubeless tyre (1) comprising a tread (2), a carcass (3) defining an inner cavity (4), an innerliner (5) designed to ensure that the air contained in the inner cavity (4) of the carcass (3) remains under pressure, a sealant layer (6) arranged in said inner cavity (4) in contact with the innerliner (5), and a sound-absorbing layer (7), which is also arranged in said inner cavity (4). The tyre comprises a support structure (8) housed inside said inner cavity (4) and designed to support said sound-absorbing layer (7), always keeping it separate from the sealant layer (6). The support structure (8) comprises a spacing portion (9) having an end in contact with said innerliner (5) and partially immersed in said sealant layer (6) and a support portion (10), on which the sound-absorbing layer (7) is fixed.

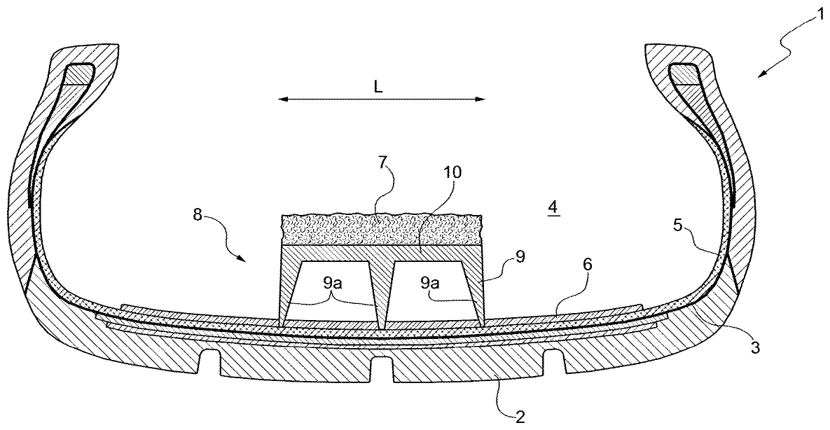

The invention relates to a tire comprising both a sealant layer to ensure the functionality of the tire itself even after it has been punctured and a sound-absorbing element to reduce the noise produced during the use.

In order to ensure the functionality of the tire even after the latter has been punctured, the use of a viscous sealant layer arranged in its inner cavity has been known for a long time. In particular, the sealant layer is arranged in contact with an impermeable layer (hereinafter referred to as “innerliner”), in the area of the tread band.

The function of the sealant layer is that of creating a sort of instantaneous “seal” around the object that penetrated the tread, thus preventing air from flowing out of the tire. Furthermore, in case the aforesaid object comes out, the material of the sealant layer has the function of filling the hole left by the object, hence sealing it.

The viscosity of the sealant layer is one of the most important parameters that allows it to effectively carry out the tasks described above. Indeed, the viscosity of the sealant layer must be such as to ensure both the sealing action to be exerted upon the object that penetrated the tread and the hole left by the object itself in a very short time, as discussed above, and its dimensional stability in the inner cavity of the tire during the rolling phase or the standing phase of the tire.

In the tire industry, the use of a sound-absorbing layer is known, which is also arranged inside the cavity of the tire. Indeed, one of the noises produced by an operating tire is the resonance cavity sound generated by the vibrations of the air under pressure present in its inner cavity, which, as it is known, is coated by the innerliner and is filled with air under pressure. The sound-absorbing layer is usually made of a foam material and is applied on the surface of the innerliner facing the cavity.

The most commonly known material used for this purpose is polyurethane foam. Indeed, polyurethane foam offers the advantage of having a low water absorption and, as a consequence, of being less subjected to a weight increase over time, with consequent advantages in terms of rolling resistance and consumptions of the vehicles deriving therefrom.

In case the sealing action and the sound-absorbing action needed to be combined in one single tire, its inner cavity should simultaneously house both the sealant layer and the sound absorbing layer. Obviously, considering the mechanism with which the sealant layer operates, the experimented engineering has adopted a sealant layer arranged in contact with the innerliner and a foam material arranged, in turn, in contact with the sealant layer on the opposite side relative to the innerliner.

This solution turned out to be ineffective, as experiments have shown that the foam material physically interacts with the sealant layer, with the consequence of jeopardizing both the sound-absorbing properties of the former and the sealing properties of the latter.

Therefore, there was the need to rely on a solution that allows manufacturers to use, in the inner cavity of a tire, both the sealant layer and the sound-absorbing element leaving, in the same time, the respective sealing and sound absorbing properties unchanged.

The inventor of this invention devised a solution that is capable of meeting the needs discussed above in a simple and economic manner.

The subject-matter of the invention is a tubeless tire comprising a tread, a carcass defining an inner cavity, an innerliner designed to ensure that the air contained in the inner cavity of the carcass remains under pressure, a sealant layer arranged in said inner cavity in contact with the innerliner, and a sound-absorbing layer, made of foamed material, which is also arranged in said inner cavity; said tyre being characterized in that it comprises a support structure housed inside said inner cavity and designed to support said sound-absorbing layer, always keeping it separate from said sealant layer; said support structure being made of polymeric non-foamed material and comprising a spacing portion having an end in contact with said innerliner and partially immersed in said sealant layer and a support portion, on which said sound-absorbing layer is fixed.

Said support structure preferably comprises a plurality of legs, each having an end in contact with said innerliner.

By so doing, the surface of the innerliner not covered by the sealant layer is minimized as much as possible.

Said support structure is preferably made of a material having a Young's modulus ranging from 1000 e 2900 N/m² and, more preferably, the distance between the support portion and a free surface of said sealant layer is at least 2 mm.

In this way, during the rotation of the tire, the support portion is prevented from bending, thus causing the sound-absorbing material to come into contact with the sealant layer, which, hence, jeopardized the effectiveness of both.

The material making up the support structure preferably is acrylonitrile butadiene styrene (ABS). ABS has a high hardness and a high impact resistance. Another of the advantages of ABS lies in its recyclability.

Another material with which the support structure can preferably be manufactured is silicone. This material has the advantage of being able to be easily removed from the tire, thus ensuring a correct recycle of the tire itself.

The support structure is preferably manufactured by means of 3D printing or injection moulding or extrusion.

The thickness of the sealant layer preferably ranges from 0.5 to 6 mm; on the other hand, the thickness of the sound-absorbing layer preferably ranges from 2 to 50 mm.

Said support portion preferably has a width ranging from 5 to 50 mm.

Hereinafter you can find a description of an embodiment of the invention, by mere way of example, with the aid of the accompanying FIGURE, which shows a cross section of the tire according to the invention.

In the aforesaid FIGURE, number 1 indicates, as a whole, a tire according to the invention.

The tire 1 comprises a tread 2, a carcass 3 defining an inner cavity 4 of the tire 1, an innerline 5 facing the inner cavity 4 and designed to make sure that the air contained in the inner cavity 4 remains under pressure, a sealant layer 6 arranged in contact with the impermeable layer 5 in the area of the tread 2, and a sound-absorbing layer 7 arranged inside the cavity 4 in order to attenuate the resonance cavity sound generated by the operating tire.

The tire 1 further comprises a support structure 8 designed to support the sound-absorbing layer 7, though keeping it separate from the sealant layer 6.

The support structure 8 comprises a spacing portion 9, which, in the example shown herein, consists of a plurality of legs 9a, and a support portion 10, on which the sound absorbing layer 7 is arranged.

The spacing portion 9 has a first end in contact with the innerliner 5 and a second end fixed to the support portion 10. According to the FIGURE, the spacing portion rests on the innerliner 5 and goes through the sealant layer 6 from which it extends, so as to keep the support portion—and, hence, the sound-absorbing layer 7 fixed to thereto—properly spaced apart from the sealant layer 6. By so doing, it is assured that the sound-absorbing layer 7 made of foamed material does not come into contact with the sealant layer 6, which could jeopardize the functionality of both. Indeed, in contact with the sealant layer there is only the support portion 10, which being not made of a nonfoamed material, will not physically interact with the sealant layer.

As a person skilled in the art can immediately understand, during the rotation of the operating tire, the support structure 8 necessarily is subjected to forces that could deform it. In order to prevent the support structure 8 from being deformed in such a way that it cannot ensure any longer the separation between the sealant layer 6 and the sound-absorbing layer 7, the material with which the support structure 8 is manufactured must preferably have a Young's modulus ranging from 1000 to 2900 N/m² and the distance between the support portion 8 and the free surface of the sealant layer 6 preferably is at least 2 mm.

In particular, the material making up the support structure 8 of the example is ABS, which has mechanical features that well suit the needs of the invention.

Another material that can advantageously be used to manufacture the support structure 8 is silicone. Silicone has the advantage of being able to be easily removed from the tire, thus ensuring a correct recycle of the tire itself.

Both possibilities may coexist within the support structure.

Owing to the above, it is evident that the invention, thanks to the presence of the support structure, allows manufacturers to produce a tire comprising, at the same time and in an effective manner, a sealant layer and a sound absorbing layer, though without being affected by the problems of the prior art. This leads to a tire whose technical features are capable both of countering the effects of a punctured tire through the sealant layer and of attenuating the noise generated inside the inner cavity by means of the sound-absorbing layer.

1-9. (canceled)

10. A tubeless tire comprising:
a tread;
a carcass defining an inner cavity;
an innerliner configured to contain air in the inner cavity such that the inner cavity remains under pressure;
a sealant layer positioned in said inner cavity and in contact with the innerliner;
a sound-absorbing layer comprising a foamed material and positioned in said inner cavity;
a support structure located within said inner cavity and configured to support said sound-absorbing layer such that the sound-absorbing layer is spaced from said sealant layer, said support structure comprising a polymeric non-foamed material;
said support structure having a spacing portion with an end in contact with said innerliner and partially immersed in said sealant layer; and
the support structure having a support portion on which said sound-absorbing layer is fixed.

11. The tubeless tire of claim 10, wherein said spacing portion comprises a plurality of legs, each of the plurality of legs in contact with said innerliner and partially immersed in said sealant layer.

12. The tubeless tire of claim 10, wherein said support structure comprises a material having a Young's modulus ranging from 1,000 N/m² to 2,900 N/m².

13. The tubeless tire of claim 12, wherein a distance between the support portion and a free surface of said sealant layer is at least 2 mm, the free surface of said sealant layer comprising a surface in which the end of the spacing portion is not partially immersed in said sealant layer.

14. The tubeless tire of claim 12, wherein the polymeric non-foamed material comprising the support structure comprises acrylonitrile butadiene stirene (ABS).

15. The tubeless tire of claim 12, wherein the polymeric non-foamed material comprising the support structure comprises silicone.

16. The tubeless tire of claim 10, wherein said support structure is manufactured by three-dimensional (3D) printing, injection moulding, or extrusion.

17. The tubeless tire of claim 10, wherein a thickness of the sealant layer ranges from 0.5 mm to 6 mm.

18. The tubeless tire of claim 10, wherein a thickness of the sound-absorbing layer ranges from 2 mm to 50 mm.

19. The tubeless tire of claim 10, wherein said support portion has a width ranging from 5 mm to 50 mm.

20. The tubeless tire of claim 10, wherein the foamed material comprising the sound-absorbing layer comprises polyurethane.

21. A tubeless tire comprising:
a tread;
a carcass defining an inner cavity;
an innerliner configured to contain air in the inner cavity such that the inner cavity remains under pressure;
a sealant layer positioned in said inner cavity and in contact with the innerliner;
a sound-absorbing layer comprising a foamed material and positioned in said inner cavity;
a support structure located within said inner cavity and configured to support said sound-absorbing layer such that the sound-absorbing layer is spaced from said sealant layer, said support structure comprising a polymeric non-foamed material;
said support structure having a spacing portion, the spacing portion comprising a plurality of legs, each of the plurality of legs in contact with said innerliner and partially immersed in said sealant layer; and
the support structure having a support portion on which said sound-absorbing layer is fixed.

22. The tubeless tire of claim 21, wherein said support structure comprises a material having a Young's modulus ranging from 1,000 N/m² to 2,900 N/m².

23. The tubeless tire of claim 22, wherein a distance between the support portion and a free surface of said sealant layer is at least 2 mm, the free surface of said sealant layer comprising a surface in which the end of the spacing portion is not partially immersed in said sealant layer.

24. The tubeless tire of claim 22, wherein the polymeric non-foamed material comprising the support structure comprises acrylonitrile butadiene stirene (ABS).

25. The tubeless tire of claim 22, wherein the polymeric non-foamed material comprising the support structure comprises silicone.

26. The tubeless tire of claim 21, wherein said support structure is manufactured by three-dimensional (3D) printing, injection moulding, or extrusion.

27. The tubeless tire of claim 21, wherein a thickness of the sealant layer ranges from 0.5 mm to 6 mm.

28. The tubeless tire of claim 21, wherein a thickness of the sound-absorbing layer ranges from 2 mm to 50 mm.

29. The tubeless tire of claim 21, wherein said support portion has a width ranging from 5 mm to 50 mm.
